(19) United States
(12) Patent Application Publication
(10) Pub. No.: US 2010/0134027 A1
(43) Pub. Date: Jun. 3, 2010

(54) MULTI-LAMP HID LUMINAIRE WITH CYCLING SWITCH

(75) Inventors: Robert L. Summerford, Selma, TX (US); Kenneth Willfong, San Marcos, TX (US)

Correspondence Address: MIDDLETON & REUTLINGER, 2500 BROWN & WILLIAMSON TOWER, LOUISVILLE, KY, 40202, US

(73) Assignee: Koninklijke Philips Electronics N.V., Eindhoven (NL)

(21) Appl. No.: 12/327,519

(22) Filed: Dec. 3, 2008

(51) Int. Cl. H05B 41/36

(52) U.S. Cl. 315/210

(57) ABSTRACT

A multi-lamp HID luminaire is provided with a HID ballast. An ignitor that produces a high voltage ignition pulse is coupled to the HID ballast and is also coupled to a plurality of HID lamp sockets that receive HID lamps. A cycling switch is also electrically coupled to the HID ballast and causes a periodic power interruption to the plurality of HID lamp sockets.

### CROSS-REFERENCE TO RELATED APPLICATIONS

Not applicable.

### BACKGROUND OF THE INVENTION

1. Field of the Invention

The present invention is related generally to an HID luminaire, and more specifically to a multi-lamp HID luminaire with a cycling switch.

2. Description of Related Art

To maintain lamp warranty and prevent non-passive lamp failure, single lamp metal halide luminaires have been provided with cycling switches. The cycling switches periodically remove power to the metal halide lamp for an amount of time prior to restoring power. The periodicity of removing power and the amount of time power is removed may be based on the suggestions of metal halide lamp manufacturers.

### BRIEF DESCRIPTION OF THE DRAWINGS

FIG. 1 is a schematic diagram of a first embodiment of a multi-lamp HID luminaire with a cycling switch of the present invention.

FIG. 2 is a schematic diagram of a second embodiment of a multi-lamp HID luminaire with a cycling switch of the present invention.

FIG. 3 is a schematic diagram of a third embodiment of a multi-lamp HID luminaire with a cycling switch of the present invention.

FIG. 4 is a bottom perspective view of a fourth embodiment of a multi-lamp HID luminaire with a cycling switch of the present invention, shown with a lens and a reflector exploded away.

FIG. 5 is a top perspective view of the multi-lamp HID luminaire with a cycling switch of FIG. 4, shown with a housing exploded away.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” “in communication with” and “mounted,” and variations thereof herein are used broadly and encompass direct and indirect connections, couplings, and mountings. In addition, the terms “connected” and “coupled” and variations thereof are not restricted to physical or mechanical connections or couplings. Furthermore, and as described in subsequent paragraphs, the specific mechanical configurations illustrated in the drawings are intended to exemplify embodiments of the invention and that other alternative mechanical configurations are possible.

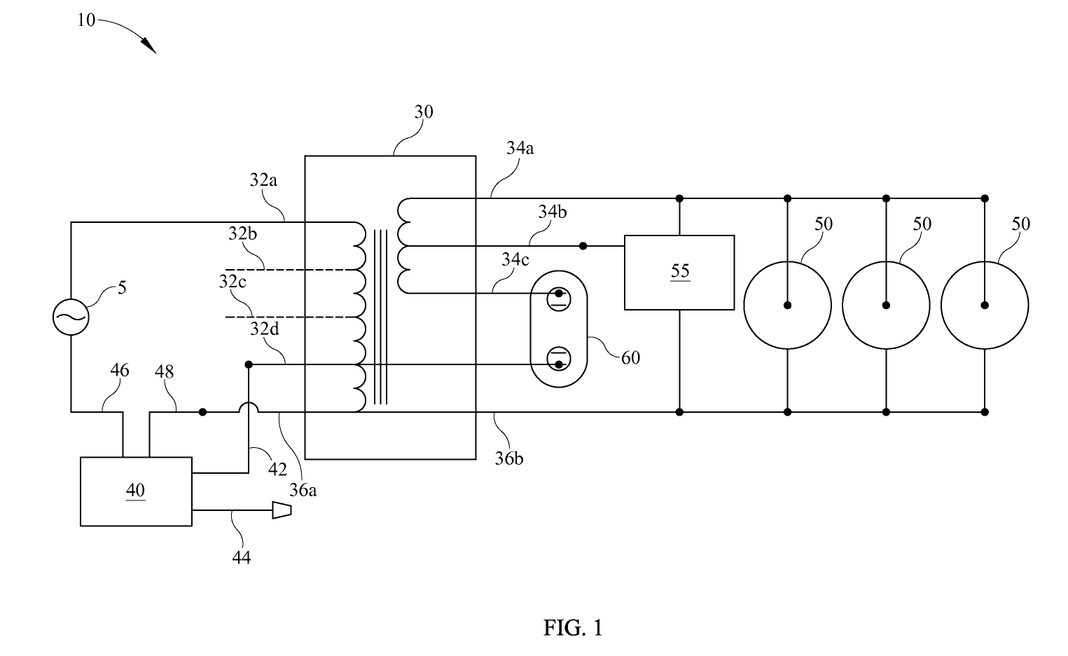

Referring now in detail to FIGS. 1-5, wherein like numerals indicate like elements throughout the several views, there are shown various aspects of a multi-lamp HID luminaire with a cycling switch. Referring to FIG. 1, a first embodiment of a multi-lamp HID luminaire with a cycling switch 10 is schematically depicted. A constant wattage autotransformer (CWA) ballast 30 is shown with input taps 32a, 32b, 32c, and 32d, output taps 34a, 34b, and 34c, and circuit common taps 36a and 36b. Input tap 32a is electrically coupled to a hot input of a power source 5 and input tap 32d is electrically coupled to a 120V connection 42 of cycling switch 40. In the embodiment of FIG. 1 input taps 32b and 32c are not used and are capped off for safety as indicated by the dashed lines. In other embodiments input taps 32b and 32c may be connected to a multi-tap power source.

In some embodiments circuit common input 46 of cycling switch 40 may be configured to be electrically coupled to a neutral input of power source 5. In some embodiments circuit common input 46 of cycling switch 40 may be configured to be electrically coupled to an additional hot input of power source 5. In some embodiments circuit common input 46 may be configured to be electrically coupled to either a neutral input of power source 5 or an additional hot input of power source 5. Circuit common tap 36a of CWA ballast 30 is electrically coupled to a circuit common connection 48 of cycling switch 40. Circuit common tap 36a is also electrically coupled to circuit common tap 36b. Except when cycling switch 40 is causing a power interruption, as discussed in more detail herein, circuit common input 46 and circuit common connection 48 are electrically coupled to one another. A 277V connection 44 of cycling switch 40 is not used in the depicted embodiment and is shown capped off for safety. In other embodiments 277V connection 44 may be electrically coupled to a HID ballast and 120V connection 42 may be unused and capped off for safety.

A capacitor 60 is electrically coupled to a first winding of CWA ballast 30 and to a second winding of CWA ballast 30. The value of capacitor 60 is chosen so that an appropriate current is produced by CWA ballast 30. Ignitor 55 is electrically coupled to output taps 34a and 34b and to circuit common tap 36b. Three HID lamps 50 are received in HID lamp sockets that are electrically coupled in a parallel configuration with one another and all three HID lamp sockets are electrically coupled to output tap 34a and circuit common tap 36b. HID lamps 50 that may be received in HID lamp sockets include Pulse Start Metal Halide (PSMH) lamps or High Pressure Sodium (HPS) lamps, either of which requires a high voltage “pulse” to “start” the lamp. Also, although three HID lamps 50 are depicted throughout all but one of the Figures, some embodiments of the invention may have only two HID lamps 50 and other embodiments of the invention may have four or more HID lamps 50. Ignitor 55 is configured to send a high voltage pulse across HID lamps 50 to establish the arc across one HID lamp 50 and start the HID lamp 50. When HID lamps 50 are electrically coupled in a parallel configuration and the pulse from ignitor 55 is provided across the leads of the HID lamps, only one HID lamp 50 will be ignited, and once one HID lamp 50 is started, ignitor 55 shuts off Ignitor 55 restarts each time power is interrupted or if a HID lamp 50 cycles off while operating.

If one HID lamp 50 is extinguished due to a power interruption or otherwise, ignitor 55 will cause the HID lamp 50 that is the “easiest” to ignite to ignite once power is restored. Which HID lamp 50 is “easiest” to ignite is dependent on the particular characteristics of each individual HID lamp 50. However, generally, cold HID lamps 50 (one that has not been recently lit) are much “easier” to ignite than hot HID lamps 50 (one that has been recently extinguished). Thus, a cold HID lamp 50 will almost always ignite over a hot HID lamp 50. Also, generally, HID lamps 50 with less burn time are “easier” to ignite than HID lamps 50 with more burn time (assuming that both lamps are the same temperature). Thus, a HID lamp 50 with less burn time is more likely to ignite than a HID lamp with more burn time.

Cycling switch 40 depicted in FIG. 1 is a “S2 Safeguard Automatic Fixture Cycling Switch” available from Thomas Research Products. Cycling switch 40 automatically cycles power to any HID ballast it is coupled to approximately once every week, thereby causing a power interruption to HID lamps 50. Cycling switch 40 is configured to quasi-randomly cycle power to any HID ballast, meaning power interruptions to any HID ballast caused by cycling switch 40 occur with irregular periodicity. For example, a first power interruption caused by cycling switch 40 may occur after one-hundred-sixty-seven hours, a second power interruption caused by cycling switch 40 may occur after one-hundred-sixty-eight hours, a third power interruption caused by cycling switch 40 may occur after one-hundred-sixty-six-and-a-half hours, and a fourth power interruption caused by cycling switch 40 may occur after one-hundred-and-sixty-eight hours. Cycling switch 40 causes a power interruption by breaking the coupling between circuit common input 46 and circuit common connection 48 to create an open circuit. The duration of the periodic power interruption is for more than an extinguishment time period and less than a warranty time period. The extinguishment time period is enough time to allow a HID lamp to fully extinguish and is typically a very brief time period of less than one second. The warranty time period is a time period mandated by manufacturers of Pulse Start Metal Halide (PSMH) lamps and may vary dependent upon the particular PSMH lamp. The warranty time period is the amount of time a PSMH lamp should be left extinguished periodically in order to prevent premature arc-tube rupture and/or to maintain the manufacturer's warranty. Some manufacturers recommend a PSMH lamp be extinguished each week and remain extinguished for at least 15 minutes.

In operation, cycling switch 40 will cause a power interruption to HID lamps 50 at least once every week. When a power interruption occurs, the HID lamp 50 that had been lit will be extinguished. When cycling switch 40 causes power to be restored to HID lamps 50, a HID lamp 50 that had not been burning will be ignited since it will be “easier” to ignite than the recently extinguished HID lamp 50. The HID lamp 50 that had been burning will remain extinguished until at least the next power interruption (whether from cycling switch 40 or otherwise) and possibly beyond, thus fulfilling any warranty requirements from manufacturers. In some embodiments cycling switch 40 will only cause a very brief power interruption. In those embodiments a HID lamp 50 that had not been burning will be ignited when power is restored, very soon after the HID lamp 50 that had been burning is extinguished. Although it may take some time for the newly lit HID lamp 50 to warm up, interruption of light output from multi-lamp HID luminaire with a cycling switch 10 will be minimized. Also, if multiple multi-lamp HID luminaires with a cycling switch 10 are present in a single environment, the irregular periodicity of power interruptions by cycling switch 40 will further minimize the interruption of light output within the environment. This irregular periodicity of cycling switch 40 decreases the likelihood that multiple multi-lamp HID luminaires with a cycling switch 10 will experience simultaneous power interruptions.

Cycling switch 40 and its placement in multi-lamp HID luminaire with a cycling switch 10 is merely exemplary of the plurality of cycling switches and plurality of placements that may cause a periodic power interruption to plurality of HID lamps 50. For example, in other embodiments cycling switch 40 may be configured such that circuit common input 46 connects to a hot input of power source 5 instead of neutral input of power source 5 and circuit common connection 48 may connect to input tap 32a. In other embodiments, for example, cycling switch may be a microcontroller electrically coupled to a relay contact that in turn is electrically coupled to a power source and an input tap of a HID ballast. In those embodiments the microcontroller can periodically cause the relay contact to be in the open position and interrupt power to the HID ballast. The microcontroller in those and other embodiments may be programmed to interrupt power with irregular periodicity. In other embodiments, for example, cycling switch may be a relay device that is normally in the open position, electrically coupled in a parallel configuration with plurality of HID lamps 50, and electrically coupled to an output tap of a HID ballast and to circuit common. The relay device can be caused to periodically be in the closed position, thus shorting plurality of HID lamps 50, interrupting power to them, and causing a HID lamp 50 to extinguish. The relay can then be caused to return to the open position and normal power restored to plurality of HID lamps 50. There are a variety of other cycling switches that may be used to periodically interrupt power to plurality of HID lamps 50 as understood by those skilled in the art. Cycling switch 40 and other cycling switches described herein are meant to be exemplary of some such cycling switches and are not meant to limit the scope of cycling switches that may be used.

In all embodiments of cycling switch the duration of the periodic power interruption is for more than an extinguishment time period and less than a warranty time period. When a periodic power interruption of this duration occurs, a “cool” HID lamp 50 and not the most recently extinguished “hot” HID lamp 50 will be ignited when power is restored. As a result, the duration of interruption of light output from a luminaire will be for less than the warranty time period and warranty requirements of lamp manufacturers will still be met. However, the exact duration of the periodic power interruption and the frequency of the power interruption may vary a great deal in different embodiments. For example, in some embodiments power is interrupted for less than two seconds and approximately once per week. In other embodiments, for example, power is interrupted for less than twenty seconds and approximately once every five days. In other embodiments, for example, power may be interrupted for five minutes or more randomly within a range of once every four to seven days.

In all embodiments of multi-lamp HID luminaire with a cycling switch, when a cycling switch causes a periodic power interruption for more than an extinguishment time period and less than a warranty time period, a HID lamp 50 that had not been burning when the power interruption occurred will be ignited since it will be “easier” to ignite than the recently extinguished HID lamp 50. The HID lamp 50 that had been burning will remain extinguished until at least the next power interruption and possibly beyond, thus fulfilling any warranty requirements from manufacturers. Moreover, when three or more HID lamps 50 are present, of the two or more HID lamps 50 that had not been burning when the power interruption occurred, the HID lamp 50 with the most burn time remaining is more likely to ignite. Thus, through periodic power interruptions from a cycling switch, the three or more HID lamps will age simultaneously no matter the remaining burn time associated with any one HID lamp 50 when initially installed. Two HID lamps 50 with similar burn time when installed will likewise experience simultaneous aging. Thus, multi-lamp HID luminaire with a cycling switch offers the advantage of extended maintenance and simultaneous maintenance on all HID lamps 50 within a single HID luminaire with a cycling switch.

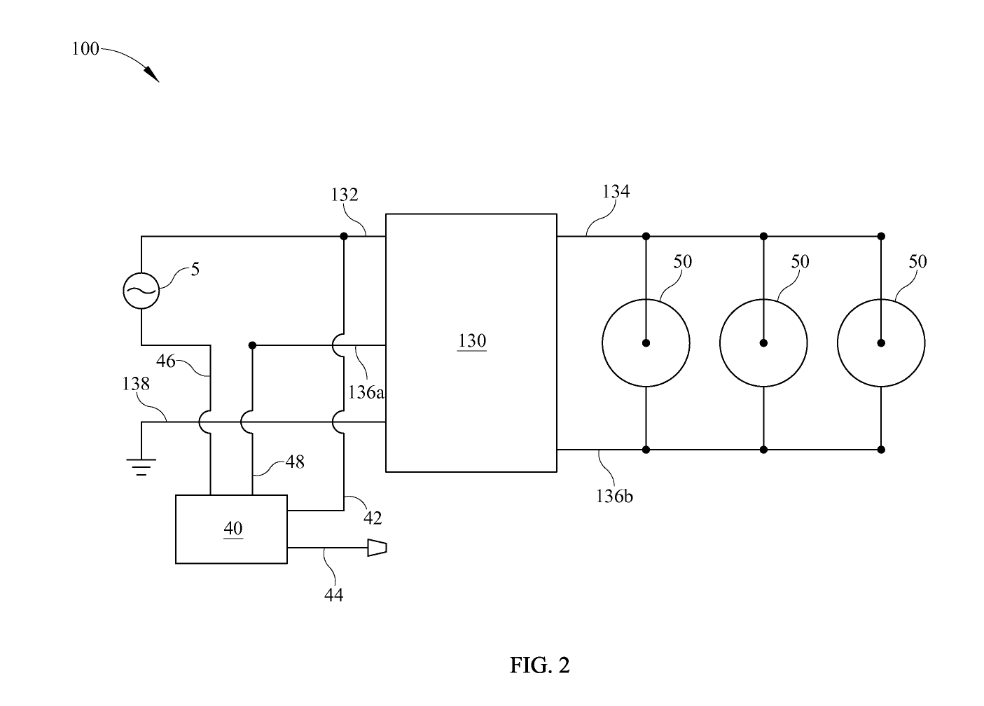

Referring to FIG. 2, a second embodiment of multi-lamp HID luminaire with a cycling switch 100 is schematically depicted. An electronic ballast 130 is shown with an input tap 132, an output tap 134, and circuit common taps 136a and 136b. Input tap 132 is electrically coupled to a hot input of a power source 5 and a 120V connection 42 of cycling switch 40. Grounding tap 138 may be electrically coupled to a ground of power source 5 if present, or to a housing of multi-lamp HID luminaire with a cycling switch 100. Circuit common input 46 of cycling switch 40 may be electrically coupled to a neutral input of power source 5 or an additional hot input of power source 5. Circuit common tap 136a of electronic ballast 130 is electrically coupled to a circuit common connection 48 of cycling switch 40. Circuit common tap 136b is electrically isolated from circuit common tap 136a. A 277V connection 44 of cycling switch 40 is not used in the depicted embodiment and is shown capped off for safety. In other embodiments 277V connection 44 may be electrically coupled to input tap 132 and 120V connection 42 may be unused and capped off for safety. Electronic ballast 130 has an integral ignitor that is electrically coupled to output tap 134 and to circuit common tap 136b and is configured to send a high voltage pulse across HID lamps 50. HID lamps 50 are electrically coupled in a parallel configuration with one another and all three are electrically coupled to output tap 134 and circuit common tap 136b.

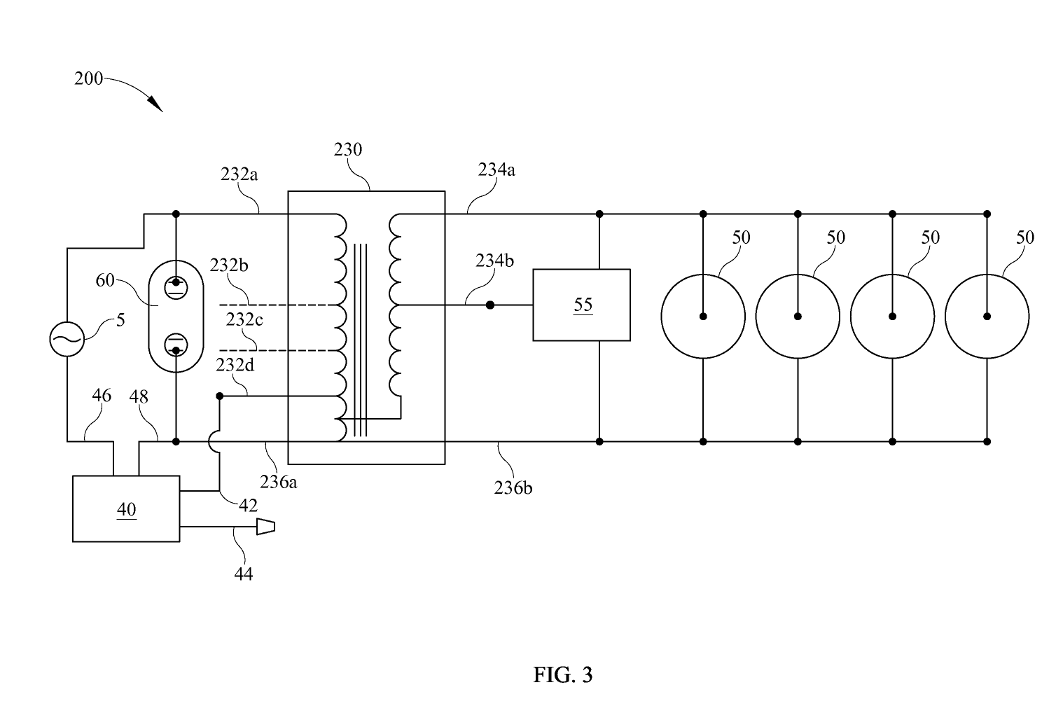

Referring to FIG. 3, a third embodiment of multi-lamp HID luminaire with a cycling switch 200 is schematically depicted. A high reactance high power factor (HX-HPF) ballast 230 is shown with input taps 232a, 232b, 232c, and 232d, output taps 234a and 234b and circuit common taps 236a and 236b. Input tap 232a is electrically coupled to a hot input of a power source 5 and input tap 232d is electrically coupled to a 120V connection 42 of cycling switch 40. In the embodiment of FIG. 3 input taps 232b and 232c are not used and are capped off for safety as indicated by the dashed lines. In other embodiments voltage input taps 232b and 232c may be connected to a multi-tap power source.

Circuit common input 46 of cycling switch 40 may be electrically coupled to a neutral input of power source 5 or an additional hot input of power source 5. Circuit common tap 236a of HX-HPF ballast 230 is electrically coupled to a circuit common connection 48 of cycling switch 40. Circuit common tap 236a is also electrically coupled to circuit common tap 236b. A 277V connection 44 of cycling switch 40 is not used in the depicted embodiment and is shown capped off for safety. In other embodiments 277V connection 44 may be electrically coupled to HX-HPF ballast 230 and 120V connection 42 may be unused and capped off for safety. A capacitor 60 is electrically coupled to input tap 232a and circuit common tap 236a and is positioned to increase the PF of HX-HPF ballast 230. In other ballast configurations capacitor 60 may be omitted. Ignitor 55 is electrically coupled to output taps 234a and 234b and to circuit common tap 236b. Four HID lamps 50 are electrically coupled in a parallel configuration with one another and all four are electrically coupled to output tap 234a and circuit common tap 236b.

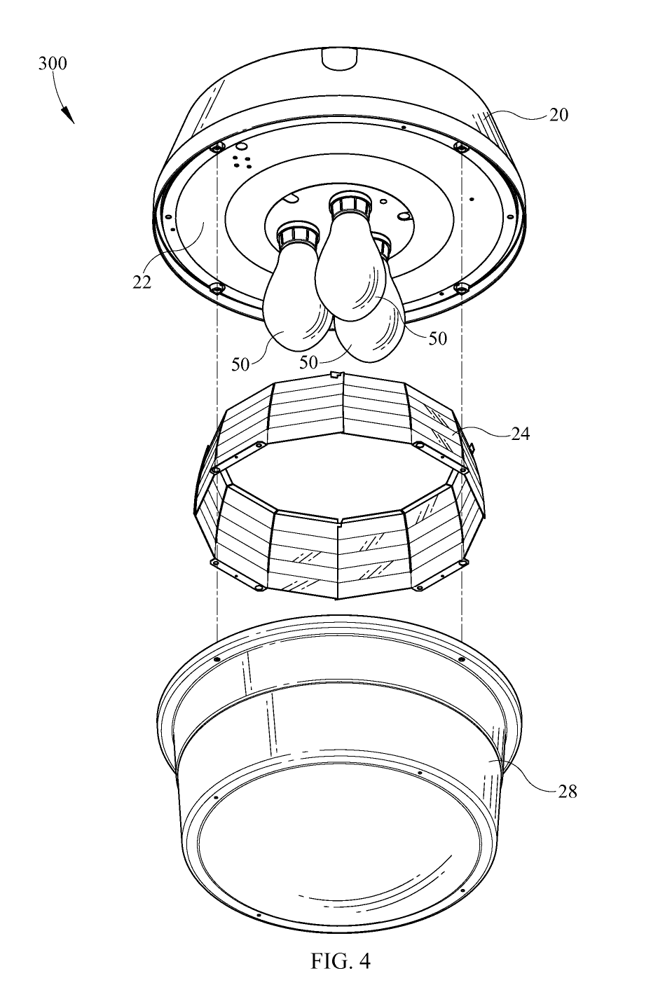

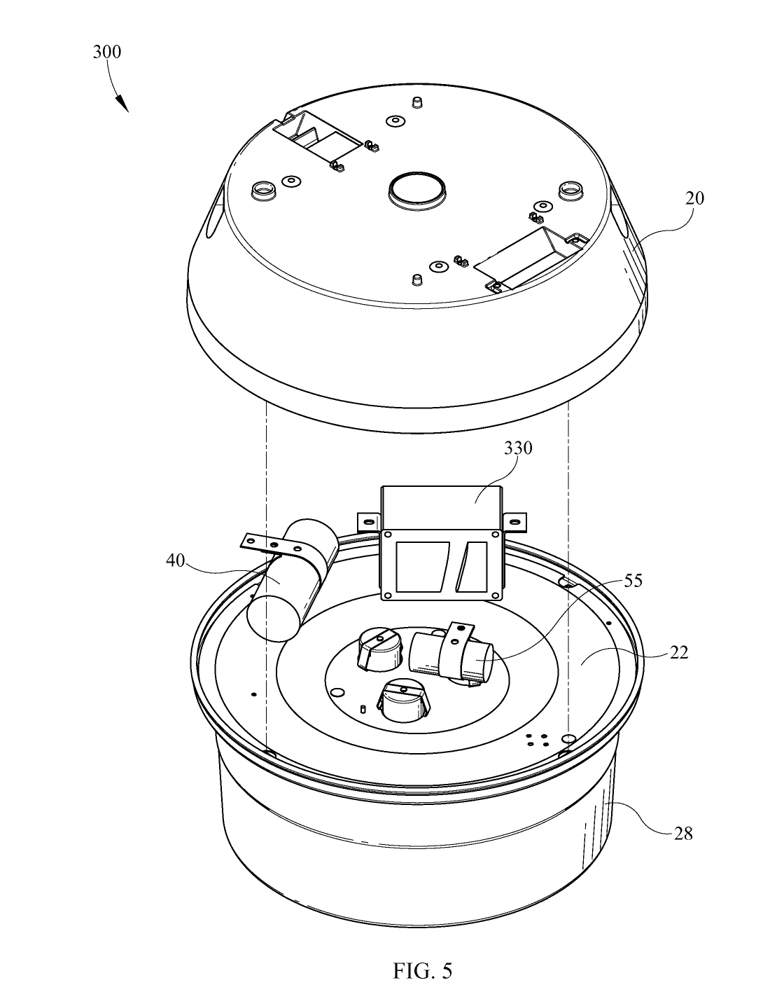

Referring to FIG. 4 and FIG. 5, a fourth embodiment of multi-lamp HID luminaire with a cycling switch 300 is depicted. Multi-lamp HID luminaire with a cycling switch 300 has a housing 20 that encloses a high reactance normal power factor (HX-NPF) ballast 330, ignitor 55, and cycling switch 40. Electrical couplings between HX-NPF ballast 330, ignitor 55, cycling switch 40, and HID lamps 50 have been omitted for clarity. A lamp mounting surface 22 forms part of housing 20 and helps enclose HX-NPF ballast 330, ignitor 55, and cycling switch 40. In some embodiments lamp mounting surface 22 also acts as a downlight reflector. Lamp mounting surface 22 provides access to HID lamp sockets for mounting HID lamps 50. A reflector 24 attaches to housing 20 and surrounds HID lamps 50. Reflector 24 is configured to provide ideal light output when only one HID lamp 50 is ignited and the other two HID lamps are extinguished. A lens cover 28 encloses HID lamps 50 and reflector 24. Cover 28 provides protection from vandalism, weather, pests, etc. and may be diffuse or non-diffuse.

Although housing 20, lamp mounting surface 22, reflector 24, and lens cover 28 are shown in FIGS. 4 and 5, they are merely provided for exemplary purposes and are merely representative of one embodiment of the invention. There are a variety of shapes, construction, orientations, and dimensions of each that may be used as understood by those skilled in the art. For example, in some embodiments housing 20 could be adapted for mounting to a support pole or other surface. For example, in some embodiments housing 20 and any ballast, cycling switch, ignitor, or capacitor it may enclose may be provided at a location remote from HID lamps 50. For example, in some embodiments only two, or four or more HID lamps 50 may be provided and may be arranged in a number of different configurations. In some embodiments reflector 24 may be omitted altogether or adapted for use with any number of HID lamps 50.

Although several ballast types and ballast configurations have been shown and described, they are merely provided for exemplary purposes and are merely representative of some embodiments of the invention. There are a variety of HID ballasts that may be used as understood by those skilled in the art. All HID ballasts receive an input from a power source and produce a refined output. The refined output may vary from the power source input in many respects including, but not limited to, having a refined voltage or current. These HID ballasts include, for example, but are not limited to CWA, Super CWA (SCWA), HX-HPF, HX-NPF, Reactor/Linear Reactor normal or high power factor, Regulated Lag, Constant Wattage Isolated (CWI), and Electronic ballasts. Also, there are a number of power sources 5 and input voltages that may function with any of the variety of HID ballasts. Moreover, cycling switch 40 or any cycling switch used in any embodiments of multi-lamp HID luminaire with a cycling switch may be adapted for use with a number of input voltages.

The foregoing description has been presented for purposes of illustration. It is not intended to be exhaustive or to limit the invention to the precise forms disclosed, and obviously many modifications and variations are possible in light of the above teaching. It is understood that while certain forms of the multi-lamp HID luminaire with a cycling switch have been illustrated and described, it is not limited thereto except insofar as such limitations are included in the following claims and allowable functional equivalents thereof

We claim:

1. A HID luminaire assembly for periodically causing a power interruption to a plurality of HID lamps, comprising:
a HID ballast that receives an input and produces a refined output, said HID ballast having a first input tap and a second input tap for receiving said input and a first output tap and a second output tap for emitting said refined output;
an ignitor that produces a high voltage ignition pulse, said ignitor electrically coupled to said first output tap and said second output tap;
a plurality of HID lamp sockets that receive HID lamps, said plurality of HID lamp sockets electrically coupled to one another in a parallel configuration and coupled to said first output tap and said second output tap of said HID ballast;
a cycling switch electrically coupled to said HID ballast;
whereby said cycling switch causes a periodic power interruption to said plurality of HID lamp sockets, said periodic power interruption having a duration of more than an extinguishment time period of HID lamps.

2. The HID luminaire assembly of claim 1, wherein said HID ballast is a CWA magnetic ballast.

3. The HID luminaire assembly of claim 1, wherein said cycling switch is electrically coupled between said ballast input and said HID ballast.

4. The HID luminaire assembly of claim 3, wherein said cycling switch is electrically coupled between said ballast input and said second input tap.

5. The HID luminaire assembly of claim 1, wherein said cycling switch is electrically coupled to said first output tap and said second output tap in a parallel configuration with said plurality of HID lamp sockets.

6. The HID luminaire assembly of claim 1, wherein said periodic power interruption is for less than twenty seconds.

7. The HID luminaire assembly of claim 1, wherein the frequency of said periodic power interruption is irregular.

8. A HID luminaire assembly for periodically causing a power interruption to a plurality of HID lamps, comprising:
a HID ballast that receives a power input and produces a refined power output, said HID ballast having a first input tap and a second input tap for receiving said power input and a first output tap and a second output tap for emitting said refined power output;
an ignitor that produces a high voltage ignition pulse, said ignitor electrically coupled to said first output tap and said second output tap;
a plurality of HID lamp sockets that receive HID lamps, said plurality of HID lamp sockets electrically coupled to one another in a parallel configuration and coupled to said first output tap and said second output tap of said HID ballast;
a cycling switch electrically coupled to said HID ballast;
whereby said cycling switch causes a periodic power interruption to said plurality of HID lamp sockets at least once per week, said periodic power interruption having a duration of more than an extinguishment time period of HID lamps;
a housing enclosing said HID ballast, said ignitor, and said cycling switch.

9. The HID luminaire assembly of claim 8, wherein said cycling switch is electrically coupled between said power input and said HID ballast.

10. The HID luminaire assembly of claim 9, wherein said cycling switch is electrically coupled between said power input and said second input tap and also has an electrical coupling to said first input tap.

11. The HID luminaire assembly of claim 8, wherein said plurality of HID lamp sockets are integrated into said housing.

12. The HID luminaire assembly of claim 8, wherein said duration of said periodic power interruption is less than ten seconds.

13. The HID luminaire assembly of claim 8, wherein at least three said HID lamp sockets are provided.

14. A HID luminaire assembly for periodically causing a power interruption to a plurality of HID lamps, comprising:
a HID ballast that receives a power input and produces a refined power output, said HID ballast having a first input tap and a second input tap for receiving said power input and a first output tap and a second output tap for emitting said refined power output;
an ignitor that produces a high voltage ignition pulse, said ignitor electrically coupled to said first output tap and said second output tap;
a plurality of HID lamp sockets that receive HID lamps, said plurality of HID lamp sockets electrically coupled to one another in a parallel configuration and coupled to said first output tap and said second output tap of said HID ballast;
a cycling switch electrically coupled to said HID ballast;
whereby said cycling switch causes an irregular periodic power interruption to said plurality of HID lamp sockets at least once per week, said periodic power interruption having a duration of less than thirty seconds;
a housing enclosing said HID ballast, said ignitor, and said cycling switch.

15. The HID luminaire assembly of claim 14, wherein at least three said HID lamp receptacles are provided.

16. The HID luminaire assembly of claim 15, wherein said cycling switch is electrically coupled between said power input and said HID ballast.

17. The HID luminaire assembly of claim 16, wherein said cycling switch is electrically coupled between said power input and said second input tap and also has an electrical coupling to said first input tap.

18. The HID luminaire assembly of claim 14, wherein said cycling switch is electrically coupled to said first output tap and said second output tap in a parallel configuration with said plurality of HID lamp sockets.

19. The HID luminaire assembly of claim 14, wherein said plurality of HID lamp sockets are integrated into said housing.

20. The HID luminaire assembly of claim 14, wherein said duration of said periodic power interruption is less than five seconds.

21. A method of cycling power to a HID luminaire, comprising:
connecting a plurality of HID lamp sockets that receive HID lamps in a parallel configuration;
connecting said plurality of HID lamp sockets to the output of an HID ballast having an ignitor;
electrically coupling a cycling switch to said HID ballast;
utilizing said cycling switch to cause an irregular periodic power interruption of less than thirty seconds to said HID lamp sockets at least once per week.
